(19) United States
(12) Patent Application Publication
(10) Pub. No.: US 2020/0044367 A1
(43) Pub. Date: Feb. 6, 2020

(54) CONNECTION STRUCTURE OF ELECTRIC WIRE AND TERMINAL

(71) Applicant: YAZAKI CORPORATION, Tokyo (JP)

(72) Inventor: Masanori Onuma, Shizuoka (JP)

(21) Appl. No.: 16/515,886

(22) Filed: Jul. 18, 2019

(30) Foreign Application Priority Data
Aug. 2, 2018 (JP) 2018-145558

(51) Int. Cl. H01R 4/18; H01R 4/28

(52) U.S. Cl. CPC H01R 4/185; H01R 4/28

(57) ABSTRACT

A connection structure of an electric wire and a terminal is provided. The terminal includes a U-shaped base portion extending from a terminal body, a first barrel erected from a first edge of one of opposite side walls of the base portion to crimp and connect a front end portion of the core wire at an end portion of the electric wire, a second barrel erected from a second edge of another of the side walls of the base portion to crimp and connect a rear end portion of the core wire. The first barrel and the second barrel are formed separately and independently, and offset from each other in an axial direction of the base portion. Further, the first barrel crimps and connects the front end portion of the core wire more strongly than crimping of the rear end portion of the core wire by the second barrel.

### CROSS-REFERENCE TO RELATED APPLICATIONS

This application is based on and claims priority under 35 USC 119 from Japanese Patent Application No. 2018-145558 filed on Aug. 2, 2018, the contents of which are incorporated herein by reference.

### TECHNICAL FIELD

The present invention relates to a connection structure of an electric wire and a terminal which is used for connection of a wire harness or the like which are, for example, electric wires disposed in a vehicle.

### BACKGROUND ART

As well known, recently, aluminum wires have been used as wire harnesses used in automobiles instead of copper wires due to demands for weight reduction of the wire harness, improvement of operability during assembling, and reduction of cost.

A structure of the terminal is also variously improved corresponding to the above, and for example, one described in Patent Document 1 below is known.

The structure of the terminal includes a barrel to be crimped onto an aluminum wire conduction portion and an insulation barrel to be crimped onto an aluminum wire covering portion. In a case where a direction opposite to a moving direction in which a crimper for terminal crimping moves when each of the barrels of the terminal is crimped is set as a height direction of the terminal, after the terminal is crimped, one part of the barrel to be crimped onto an aluminum wire conduction portion is formed as a portion crimped on an aluminum wire conduction portion with a lower height, and the other part of the barrel to be crimped onto an aluminum wire conduction portion is formed as a portion crimped to hold an aluminum electric wire with a higher height. Further, the terminal is formed as a tapered to-be-crimped portion including an inclined portion so as to connect the portion crimped on an aluminum electric wire conduction portion which is strongly crimped by the crimper for terminal crimping and the portion crimped to hold an aluminum electric wire which is loosely crimped in the height direction.

The tapered to-be-crimped portion including such an inclined portion is provided, so that it is possible to prevent occurrence of cracks in a boundary region between the portion crimped to hold an aluminum wire and the portion crimped on an aluminum wire conduction portion.

Patent Document 1: JP-A-2009-176547

### SUMMARY OF INVENTION

However, when the conventional terminal crimping structure described in the above patent literature is applied to, for example, an ultra-small terminal or an ultrafine wire corresponding to a narrow pitch connector, there may be the following technical problem.

That is, since a thickness of an ultra-small terminal is formed to be small, cracks may occur at the tapered to-be-crimped portion with an inclined shape in the boundary region between the portion crimped on an aluminum wire conduction portion and the portion crimped to hold an aluminum wire during crimping.

The present invention has been made in view of the technical problem in the related art, and an object thereof is to provide a connection structure of an electric wire and a terminal in which a first barrel and a second barrel which are configured to crimp a core wire of the electric wire strongly and loosely are separately independent in an axial direction, thus eliminating occurrence of cracks between the two barrels.

A first aspect of the invention provides a connection structure of an electric wire and a terminal. An electric wire includes a core wire; and a covering portion which covers the core wire. A terminal includes a substantially U-shaped base portion which extends along a longitudinal direction of a terminal body; a first barrel which is erected from a first edge of one of opposite side walls of the base portion and is configured to crimp and connect a front end portion of the core wire exposed from the covering portion at an end portion of the electric wire; a second barrel which is erected from a second edge of another of the opposite side walls of the base portion and is configured to crimp and connect a rear end portion of the core wire; and a third barrel which is configured to crimp and connect the covering portion. The first barrel and the second barrel are formed separately and independently in an axial direction of the base portion, and are offset from each other in an axial direction of the base portion. The first barrel is configured to crimp and connect the front end portion of the core wire more strongly than crimping of the rear end portion of the core wire by the second barrel.

According to the present invention, since there is originally no boundary portion between the first barrel and the second barrel to connect the first barrel and the second barrel, it is possible to eliminate the occurrence of cracks in the boundary portion during crimping.

The first barrel can increase the electrical conductivity due to reduction of electrical resistance by over-crimping the front end portion of the core wire (increasing a compression ratio). Meanwhile, the second barrel can secure mechanical strength and increase bonding force by loosely crimping the rear end portion of the core wire (reducing the compression ratio).

According to a second aspect of the invention, the third barrel is formed with a plurality of barrel pieces that are disposed separately and independently in the axial direction of the base portion and are erected from the first edge and the second edge of the base portion respectively, and the plurality of the barrel pieces are offset from each other in the axial direction of the base portion so as to crimp the cover portion in a holding state.

1 In short, according to the present invention, the following can be achieved: (1) The crimping is performed such that the first and second barrels do not bite into the core wire; (2) Both electrical and mechanical characteristics are secured even in an ultra-fine electric wire; and (3) Reduction in outer diameter (narrow pitch) can be realized even in a state where the third barrel is crimped.

According to the present invention, occurrence of cracks between the first barrel and the second barrel during crimping can be avoided, while enabling size reduction of the terminal.

### BRIEF DESCRIPTION OF DRAWINGS

FIG. 1 is a side view showing a state where an electric wire is to be mounted to a terminal provided in an embodiment of the present invention.

FIG. 2 is a plan view showing a state where each barrel of the terminal of the present embodiment is crimped.

FIG. 3 is a front view showing a crimper for terminal crimping provided in the present embodiment.

FIG. 4 is a cross-sectional view of the crimper for terminal crimping taken along a line D-D of FIG. 4.

FIG. 5 is a view showing a state of the terminal in the present embodiment before being crimped by the crimper for terminal crimping, as viewed from an axial direction of the electric wire.

FIGS. 6A to 6C are cross-sectional views taken along lines A-A to C-C in FIG. 2, wherein FIG. 6 A is a cross-sectional view taken along the line A-A in FIG. 2, FIG. 6B is a cross-sectional view taken along the line B-B in FIG. 2, and FIG. 6C is a cross-sectional view taken along the line C-C in FIG. 2.

### DESCRIPTION OF EMBODIMENTS

Hereinafter, a connection structure of an electric wire and a terminal according to the present invention will be described with reference to the drawings. In the embodiment, the connection structure is applied to a terminal to be held by a connector for connection of an electric wire to be connected to an electrical equipment of an automobile.

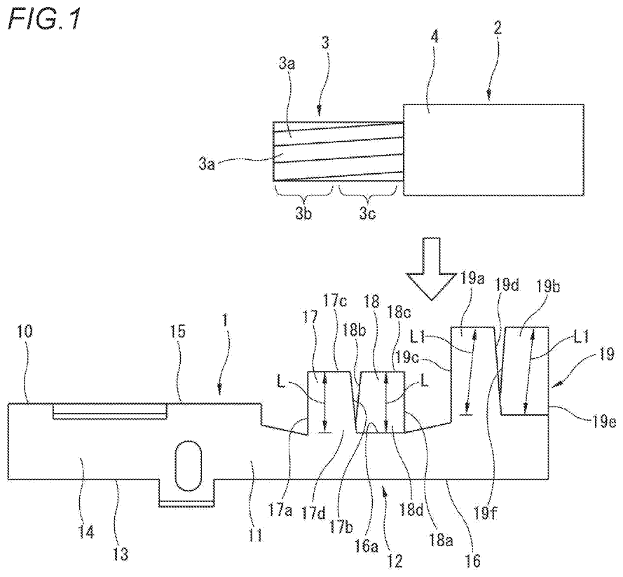

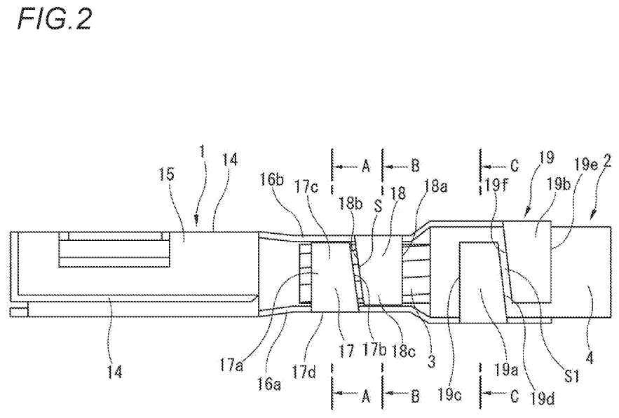

FIG. 1 is a side view showing a state where an electric wire is to be connected to a terminal provided in an embodiment of the present invention, and FIG. 2 is a plan view showing a state where each barrel of the terminal provided in the present embodiment is pressed and crimped.

A connector in which a terminal 1 is accommodated includes a connector housing formed of box-shaped synthetic resin material having a plurality of terminal accommodation holes (cavities) inside.

As shown in FIG. 1 and FIG. 2, the terminal 1 is integrally formed by bending a metal plate of a conductive material such as copper or copper alloy into a cylindrical shape by press molding, and is configured by a terminal body 10 which is on a front end side and is formed substantially in a rectangular tube shape, and a barrel portion 12 which is integrally coupled to a rear end side of the terminal body 10 via a connection portion 11 and is to be crimped and connected to an end of the electric wire 2.

In the present embodiment, the electric wire 2 is configured by, for example, a core wire 3 configured by seven stranded wires 3a formed of copper material, and a covering portion 4 which is formed of flexible synthetic resin material and covers an outer circumference of the core wire 3. A part of the core wire 3 which on an end portion side in an axial direction of the electric wire 2 is exposed from an end portion of the covering portion 4, and the end portion side of the electric wire 2 is to be connected to the terminal 1.

The core wire 3 is formed to be extremely thin to an extend that a total outer diameter of the stranded wires 3a is about 0.5 mm in the present embodiment, but the core wire 3 may be thicker or thinner than the above.

The terminal body 10 is briefly described for having a well-known structure, and includes a bottom wall portion 13 which is formed in a rectangular tube shape long in a front-rear direction, and whose front end portion side is double overlapped, a pair of side wall portions 14 which are erected substantially vertically from both side edges of the bottom wall portion 13, and an upper wall portion 15 which is provided on upper end edges of the both side wall portions 14, and all of these wall portions 13 to 15 configure an outer wall.

In the terminal body 10, an opening (not shown) through which a male terminal is inserted is formed at a front end portion separated by the wall portions 13 to 15.

Two contact beads which are in contact with a front end portion of the male terminal to be inserted into an interior of the bottom wall portion 13 from the opening, are formed to be elongated and parallel along a longitudinal direction.

The upper wall portion 15 is formed in parallel with the bottom wall portion 13, and a lance hole is formed at a substantially central position close to a rear end portion in the longitudinal direction of the terminal body 10, to which a front end portion of a lance portion of the connector housing is engaged.

In addition, a contact spring which elastically sandwiches the male terminal in cooperation with the contact beads is integrally provided at a front end portion of the upper wall portion 15.

The side wall portions 14 are integrally provided with a pair of stabilizers on both side portions of the lance hole.

The barrel portion 12 includes a semi-cylindrical base portion 16 which extends in the longitudinal direction continuously from an end portion of the bottom wall portion 13, and three barrels, first to third barrels 17, 18, 19 which are integrally erected up from a pair of upper end edges 16a. 16b of both side walls of the base portion 16 in FIG. 1.

The base portion 16 is formed to have a substantially U-shaped cross section, and as shown in FIG. 1, the upper end edges 16a, 16b of both side walls are formed to be inclined downward toward a first barrel 17 side from the connection portion 11 on the front end side, and are formed substantially horizontally on a first barrel 17 side and a second barrel 18 side, respectively. Further, each of the upper end edges 16a, 16b is formed to be inclined upward from the second barrel 18 side to a third barrel 19 side, and thus a length (height) of the base portion 16 on the third barrel 19 side is set to be large.

The first barrel 17 and the second barrel 18 crimp front and rear end portions 3b, 3c of the core wire 3 exposed from an end portion of the electric wire 2, and are offset from each other in an axial direction of the base portion 16 (electric wire 2) while being erected on one upper end edge 16a and the other upper end edge 16b of the base portion 16, respectively.

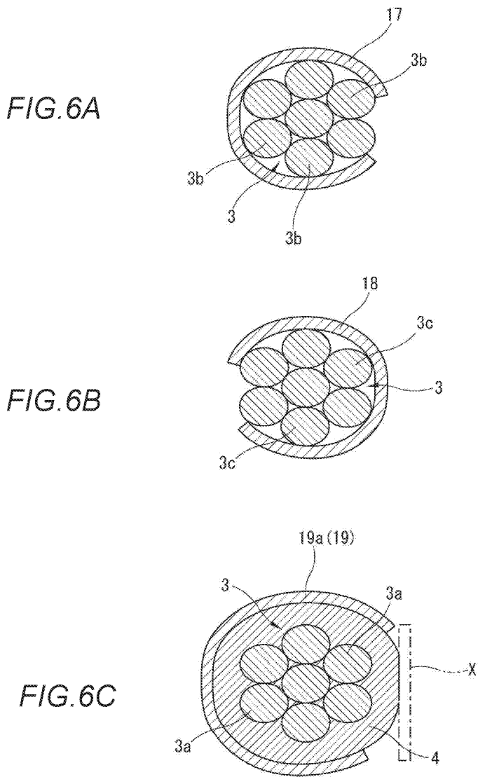

Specifically, the first barrel 17 and the second barrel 18 are offset in the axial direction of the base portion 16 and are disposed in a staggered manner so as not to overlap each other. The heights (lengths L) of the first barrel 17 and the second barrel 18 extending from the upper end edges 16a. 16b of the base portion 16 are set to be substantially the same, and the lengths L are separately formed, as shown in FIG. 6A and FIG. 6B, to be shorter than a circumferential length of the core wire 3 in a state of being bent in a curved shape along an outer circumferential surface of the core wire 3.

The first barrel 17 is formed in a rectangular shape extending upward from one upper end edge 16a of the base portion 16, and a formation position of the first barrel 17 is disposed closer to the connection portion 11 (the terminal body 10). The first barrel 17 is configured such that a front end portion 3b side of the core wire 3 is over-crimped (increase compression ratio) by a crimper 20 for terminal crimping to be described later.

The first barrel 17 is formed substantially vertically such that one side edge 17a on a connection portion 11 side is orthogonal to the longitudinal direction of the base portion 16, and the other side edge 17b on the third barrel 19 side is formed to be inclined from an upper end portion 17c to a lower end portion 17d on a base portion 16 side. That is, the other side edge 17b is cut-formed in an inclined shape which has a downward slope from a lower end portion 17d side to an upper end portion 17c side.

Meanwhile, the second barrel 18 is formed in a rectangular shape extending upward from the other upper end edge 16a of the base portion 16, a formation position of the second barrel 18 is disposed closer to the third barrel 19 and the second barrel 18 is offset to the third barrel 19 side with respect to the first barrel 17.

The second barrel 18 is formed substantially vertically such that one side edge 18a on the third barrel 19 side is orthogonal to the longitudinal direction of the base portion 16, and the other side edge 18b on the connection portion 11 side is formed to be inclined from an upper end portion 18c to a lower end portion 18d on the base portion 16 side. That is, the other side edge 18b is cut-formed in an inclined shape which has a downward slope from a lower end portion 18d side to an upper end portion 18c side.

The second barrel 18 is configured such that a rear end portion 3c side of the core wire 3 is loosely crimped (reduce compression ratio) by the crimper 20 for terminal crimping to be described later.

Therefore, in a state where the first barrel 17 and the second barrel 18 are caulked by the crimper 20 for terminal crimping so as to over-crimp or loosely crimp the core wire 3 respectively, as shown in FIG. 2, the first barrel 17 and the second barrel 18 are disposed parallel to each other via an inclined gap S formed between the other side edges 17b, 18b of the barrels 17, 18.

As shown in FIG. 1 and FIG. 2, the third barrel 19 crimps the front and rear of the covering portion 4 of the electric wire 2, and is configured by two barrel pieces 19a, 19b which are erected on one upper end edge 16a and the other upper end edge 16b of the base portion 16, respectively. The two barrel pieces 19a, 19b are offset from each other in the axial direction of the base portion 16.

The heights (lengths L1) of the two barrel pieces 19a, 19b are set to be substantially the same, and the length L1 is formed longer than the lengths L of the first barrel 17 and the second barrel 18 in accordance with a thickness of the covering portion 4.

The lengths of the two barrel pieces 19a, 19b extending from each upper end edges 16a, 16b of the base portion 16 are set to be substantially the same, and the length is separately formed, as shown in FIG. 6C, to be shorter than a circumferential length of the covering portion 4 in a state of being bent in a curved shape along an outer circumferential surface of the covering portion 4.

One barrel piece 19a is formed in a rectangular shape extending upward from one upper end edge 16a of the base portion 16, and a formation position of the barrel piece 19a is disposed closer to the connection portion 11. The barrel piece 19a is configured such that a front end portion side of the covering portion 4 is crimped by the crimper 20 for terminal crimping to be described later.

Further, the barrel piece 19a is formed substantially vertically such that one side edge 19c on the terminal body 10 side is orthogonal to the longitudinal direction of the base portion 16, and the other side edge 19d is formed to be inclined from an upper end portion to a lower end portion on the base portion 16 side. That is, the side edge 19d is cut-formed in an inclined shape which has a downward slope from a lower end portion side to an upper end portion side.

Meanwhile, the barrel piece 19b is formed in a rectangular shape extending upward from the other upper end edge 16b of the base portion 16, a formation position of the barrel piece 19b is offset to a side opposite to the terminal body 10 side with respect to one barrel piece 19a. The barrel piece 19b is caulked by the crimper 20 for terminal crimping so as to crimp a rear end portion side of the covering portion 4.

Further, the barrel piece 19b is formed substantially vertically such that one side edge 19e is orthogonal to the longitudinal direction of the base portion 16, and the other side edge 19f on the terminal body 10 side is formed to be inclined from an upper end portion to a lower end portion on the base portion 16 side. That is, the side edge 19f is cut-formed in an inclined shape which has a downward slope from a lower end portion side to an upper end portion side.

Therefore, in a state where the two barrel pieces 19a, 19b are caulked by the crimper 20 for terminal crimping so as to crimp the outer circumferential surface of the covering portion 4, as shown in FIG. 2, the two barrel pieces 19a, 19b are disposed substantially parallel to each other via an inclined gap S1 formed between the other side edges 19d, 19f of the two barrel pieces 19a, 19b.

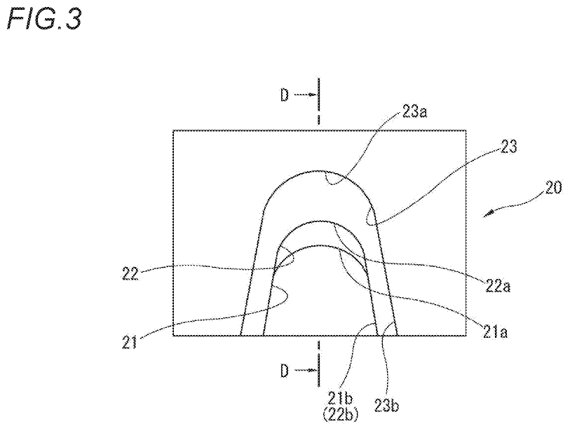

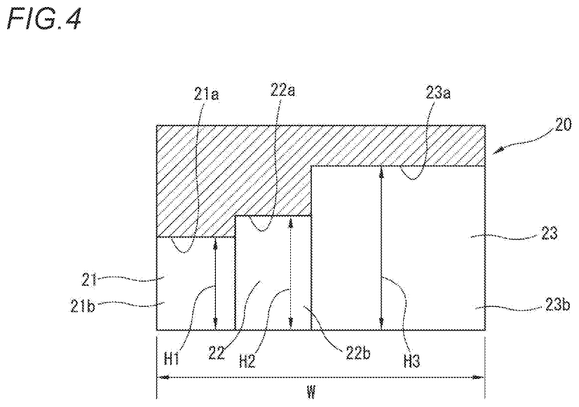

FIG. 3 is a front view showing a crimper for terminal crimping provided in the present embodiment, and FIG. 4 is a cross-sectional view of the crimper for terminal crimping taken along the line D-D of FIG. 3.

The crimper 20 for terminal crimping is formed of, for example, iron-based metal in a block shape, and arch-shaped first to third crimping grooves 21 to 23 are formed stepwise inside the crimper 20 for terminal crimping at positions corresponding to the first barrel 17, the second barrel 18 and the third barrel 19 (barrel pieces 19a, 19b) respectively.

That is, in the first to third crimping grooves 21 to 23, heights H1 to H3 from a center of each lower end portions 21b to 23b of each inner peripheral surface to each top portions 21a to 23a vary according to an amount of crushing by crimping of each of the barrels 17 to 19 and an outer diameter of each of the barrels 17 to 19. That is, the first crimping groove 21 corresponding to the over-crimped first barrel 17 has the lowest height H1, and the second crimping groove 22 corresponding to the loosely crimped second barrel 18 has a height H2 higher than H1. The third crimping groove 23 corresponding to each of the barrel pieces 19a, 19b of the third barrel 19 has the largest height H3 since the third crimping groove 23 crimps the covering portion 4 having a largest diameter.

Specifically, an inner peripheral surface of the first crimping groove 21 corresponding to the first barrel 17 is formed in a small arch shape, and an outer peripheral surface of the first barrel 17 is crimped from above by the rounded top portion 21a side so as to be bent and deformed inwardly. Thus, a front end portion 3b side of the core wire 3 is over-crimped.

An inner peripheral surface of the second crimping groove 22 corresponding to the second barrel 18 is formed in a middle arch shape, and an outer peripheral surface of the second barrel 18 is crimped from above by the rounded top portion 22a side so as also to be bent and deformed inwardly. Thus, a rear end portion 3c side of the core wire 3 is loosely crimped.

An inner peripheral surface of the third crimping groove 23 corresponding to each barrel piece 19a, 19b of the third barrel 19 is formed in a large arch shape, and outer peripheral surfaces of the barrel pieces 19a. 19b are crimped from above at a predetermined pressure by the top portion 23a side so as to be bent and deformed inwardly relative to each other. Thus, the covering portion 4 is crimped via the barrel piece 19a, 19b.

The crimping grooves 21 to 23 are formed to be widen from the top portions 21a to 23a toward the lower end portions 21b to 23b.

The crimper 20 for terminal crimping is moved up and down by a lifting mechanism (actuator) not shown, bends and deforms the first to third barrels 17 to 19 inwardly relative to each other substantially at the same time, and is separated from each of the barrels 17 to 19 after deformation.

### (Crimping Step of Each Barrel)

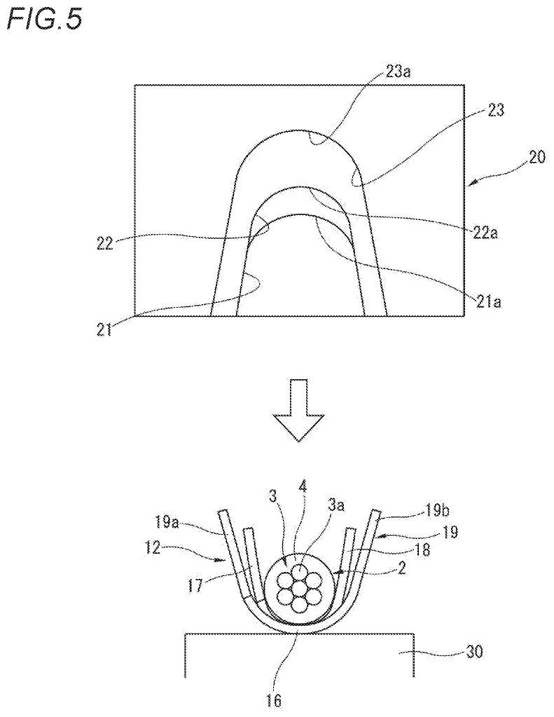

FIG. 5 is a view showing a state of the terminal in the present embodiment before being crimped by the crimper for terminal crimping, as viewed from the axial direction of the electric wire. FIGS. 6A to 6C are cross-sectional views taken along lines A-A to C-C in FIG. 2, wherein FIG. 6 A is a cross-sectional view taken along the line A-A in FIG. 2, FIG. 6B is a cross-sectional view taken along the line B-B in FIG. 2, and FIG. 6C is a cross-sectional view taken along the line C-C in FIG. 2.

Hereinafter, crimping steps of the first to third barrels 17 to 19 by the crimper 20 for terminal crimping will be described based on FIG. 5.

First, the terminal 1 is fixed on a base 30, and the end portion of the electric wire 2 is positioned at a predetermined location inside the terminal 1 in this state. That is, the covering portion 4 of the electric wire 2 is positioned in a region sandwiched by the third barrel 19 and the core wire 3 is positioned in a region sandwiched by the first barrel 17 and the second barrel 18. In this state, positions in an upper-lower direction of the first to third crimping grooves 21 to 23 of the crimper 20 for terminal crimping are determined depending on the corresponding first to third barrels 17 to 19 (19a, 19b).

Next, the crimper 20 for terminal crimping is moved down by the lifting mechanism, and the side edges on the upper end portion side of each of the barrels 17 to 19 (19a, 19b) are pushed inward by lower end portions 21b to 23b side of the inner peripheral surfaces of the crimping grooves 21 to 23, respectively. Thus, each of the barrels 17 to 19 (19a, 19b) are deformed in a direction approaching each other inwardly.

Then, when the crimper 20 for terminal crimping is further moved down, the barrels 17 to 19 are further pushed inwardly to be bent and deformed so as to be substantially parallel without overlapping with each other. Therefore, as shown in FIG. 6A and FIG. 6B, the front end portion 3b of the core wire 3 of the electric wire 2 is over-crimped by the first barrel 17, and the rear end portion 3c of the core wire 3 is loosely crimped by the second barrel 18. Meanwhile, as shown in FIG. 6C, the covering portion 4 of the electric wire 2 is crimped by the barrel pieces 19a, 19b of the third barrel 19.

Thus, the first barrel 17 and the second barrel 18 crimp the outer circumferential surfaces of the front end portion 3b and the rear end portion 3c of the core wire 3 from opposite directions relative to each other in a holding state, and the barrel pieces 19a, 19b of the third barrel 19 also crimp the outer circumferential surface of the covering portion 4 from opposite directions relative to each other in a holding state. Therefore, a bonding force to the core wire 3 and the covering portion 4 is increased.

That is, the first barrel 17, the second barrel 18 and the barrel pieces 19a. 19b crimp the front and rear of the core wire 3 and the covering portion 4 in a stagger form from opposite sides sandwiching the base portion 16.

Further, crimping forces (compression ratio) of the core wire 3 by the first barrel 17 and the second barrel 18 are different due to a difference in formation positions of the first crimping groove 21 and the second crimping groove 22, the crimping force against the front end portion 3b of the core wire 3 by the first barrel 17 results in over-crimping (high compression ratio), and the crimping force against the rear end portion 3c of the core wire 3 by the second barrel 18 is lower than the crimping force of the first barrel 17 and results in loose crimping (low compression ratio).

Therefore, an amount of crushing on the front end portion 3b of the core wire 3 by the first barrel 17 is large, so that an oxide film on the surface is easily broken, the electrical resistance is reduced, and the electrical conductivity is improved. Meanwhile, an amount of crushing on the rear end portion 3c of the core wire 3 by the second barrel 18 is smaller than that of the front end portion 3b, so that reduction in mechanical strength is suppressed, and a bonding force of the second barrel 18 against the rear end portion 3c is increased.

That is, electrical characteristics are secured by over-crimping to the front end portion 3b of the core wire 3 by the first barrel 17, and the mechanical characteristics are secured by loose crimping to the rear end portion 3c of the core wire 3 by the second barrel 18.

In other words, in both the first barrel 17 and the second barrel 18, since damage to the core wire 3 is increased in a case where the extremely thin core wire 3 is over-crimped, the second barrel 18 is crimped more loosely than the first barrel 17. In both the first barrel 17 and the second barrel 18, since electrical characteristics cannot be ensured in a case of loose crimping, the first barrel 17 is crimped more strongly than the second barrel.

Since the first barrel 17 and the second barrel 18 are formed separately and independently, the over-crimping force on the first barrel 17 by the first crimping groove 21 does not affect the crimping force on the second barrel 18. Therefore, the first crimping groove 21 and the second crimping groove 22 provide high-precision crimping forces to the first barrel 17 and the second barrel 18, respectively.

Further, as described above, the first barrel 17 and the second barrel 18 are formed separately and independently from each other, and only the inclined gap S is formed at a boundary portion between the two barrels. Therefore, there is no tapered crimped portion at the boundary portion between the two barrels 17, 18, unlike that in the related art. For this reason, even if the terminal 1 is microminiaturized or thinned or the core wire 3 of the electric wire 2 is made extremely thin, no crack occurs on the terminal during crimping. As a result, durability of the terminal 1 is improved.

In the present embodiment, the crimping grooves 21 to 23 of the crimper 20 for terminal crimping are simply arch shaped corresponding to structures of the barrels 17 to 19, that is, each of the top portions 21a to 23a is formed in a rounded shape, so that manufacturing operation of the crimper 20 for terminal crimping is facilitated extremely as compared with the related art.

That is, in a case where the invention in related art is applied to an ultra-small terminal, since a width of the terminal is very short, it is difficult to form and process a crimper for terminal crimping which crimps the portion crimped on an aluminum electric wire conduction portion and the portion crimped to hold an aluminum electric wire. That is, since the crimper for terminal crimping crimps and deforms the two crimped portions into a heart shape from an outside to an inside by a reverse V-shaped crimping groove, it is difficult to perform two complicated round processing corresponding to each heart shape in the ultra-small terminal.

In contrast, since the crimping grooves 21 to 23 of the crimper 20 for terminal crimping according to the present embodiment are formed in a rounded shape corresponding to the simple arc shape of each of the barrels 17 to 19, it is not necessary to increase the processing accuracy of the crimping grooves 21 to 23, so that processing operation is facilitated. Therefore, manufacturing cost of the crimper 20 for terminal crimping can be reduced.

The crimping grooves 21 to 23 of the crimper 20 for terminal crimping are overlapped on the barrels 17 to 19 from above and perform crimping simultaneously and together in one press operation, so that crimping operation is also facilitated and productivity is improved.

As described above, each barrel piece 19a. 19b of the third barrel 19 is bent and deformed into a substantially C shape along the outer circumferential surface of the covering portion 4 so as to perform crimping, as shown in FIG. 6C, so that an outer diameter of a non-crimped portion X can be reduced by a barrel thickness (one barrel piece). Thus, pitch of a connector can be narrowed.

Further, the facing side edges 17b, 18b of the first barrel 17 and the second barrel 18 are cut-formed to be inclined in the same direction, so that an amount of offset in the axial direction of both barrels 17, 18 can be reduced.

For this reason, not only the crimping force of the crimper 20 for terminal crimping be sufficiently transmitted, but also the axial length of the first crimping groove 21 and the second crimping groove 22 can be shortened.

Further, the facing side edges 19d, 19f of the two barrel pieces 19a. 19b of the third barrel 19 are cut-formed to be inclined in the same direction, so that an amount of offset in the axial direction of the barrel pieces 19a, 19b can be reduced.

For this reason, not only the crimping force of the crimper 20 for terminal crimping be sufficiently transmitted, but also the axial length of the third crimping groove 23 can be shortened.

As a result, as shown in FIG. 4, a width W of the crimper 20 for terminal crimping in the axial direction of the electric wire 2 can be sufficiently shortened, and a size of the crimper 20 for crimping the terminal can be reduced.

The present invention is not limited to the configuration of the above embodiment, for example, the core wire 3 of the electric wire 2 can be formed of aluminum wire instead of a copper wire, and a material of the terminal 1 can also be changed to aluminum, brass or the like rather than copper.

Further, the number of the barrels 17 to 19 can be increased or decreased depending on a specification and a size of the connector and the terminal 1, and the axial width of each wire can also be arbitrarily changed.

The third barrel 19 is configured by the two barrel pieces 19a, 19b, but it is also possible to configure the third barrel 19 by one with a wider width.

What is claimed is:

1. A connection structure of an electric wire and a terminal comprising:
an electric wire including:
a core wire; and
a covering portion which covers the core wire; and
a terminal including:
a substantially U-shaped base portion which extends along a longitudinal direction of a terminal body;
a first barrel which is erected from a first edge of one of opposite side walls of the base portion and is configured to crimp and connect a front end portion of the core wire exposed from the covering portion at an end portion of the electric wire;
a second barrel which is erected from a second edge of another of the opposite side walls of the base portion and is configured to crimp and connect a rear end portion of the core wire; and
a third barrel which is configured to crimp and connect the covering portion,
wherein the first barrel and the second barrel are formed separately and independently in an axial direction of the base portion, and are offset from each other in an axial direction of the base portion,
the first barrel is configured to crimp and connect the front end portion of the core wire more strongly than crimping of the rear end portion of the core wire by the second barrel.

2. The connection structure of an electric wire and a terminal according to claim 1,
wherein the third barrel is formed with a plurality of barrel pieces that are disposed separately and independently in the axial direction of the base portion and are erected from the first edge and the second edge of the base portion respectively, and
the plurality of the barrel pieces are offset from each other in the axial direction of the base portion so as to crimp the cover portion in a holding state.
